(19) United States
(12) Patent Application Publication
(10) Pub. No.: US 2009/0199444 A1
(43) Pub. Date: Aug. 13, 2009

(54) ILLUMINATED MESSAGE BOARD

(75) Inventor: John M. Robinson, Sarasota, FL (US)

Correspondence Address: GIFFORD, KRASS, SPRINKLE,ANDERSON & CITKOWSKI, P.C, PO BOX 7021, TROY, MI, 48007-7021, US

(73) Assignee: Spectrum Research Group Inc., Sarasota, FL (US)

(21) Appl. No.: 11/769,440

(22) Filed: Jun. 27, 2007

Related U.S. Application Data
(60) Provisional application No. 60/818,139, filed on Jun. 30, 2006.

(51) Int. Cl. G09F 13/18

(52) U.S. Cl. 40/546

(57) ABSTRACT

The message board of the present invention includes a base unit and a writing board that can fit within a channel of the base unit and be removed therefrom. The base unit can include a light and may be operable to be plugged directly into a wall outlet. A switch can also be included on the base unit to activate and deactivate the light. The base has a front surface with an arm extending outwardly therefrom and tie arm having a flange spaced apart from and extending generally parallel to the front surface. The front surface, the arm and the flange define a channel, the channel having a dimension such that the writing board can fit and rest therein. The channel also has a floor region which allows light to shine therethrough. The writing board can have a written message thereon and is operable to allow light to illuminate the written message when placed within the channel of the base and light shines through the floor region of the channel. Using, for example, a wet erase fluorescent marker, a user may write a message on the writing board and then place the writing board back into the base unit so that the message may be illuminated by light shining through the floor region of the channel.

### CROSS-REFERENCE TO RELATED APPLICATIONS

This application claims priority of U.S. Provisional Patent Application Ser. No. 60/818,139 filed Jun. 30, 2006, which is incorporated herein by reference.

### FIELD OF THE INVENTION

The present invention is directed to an illuminated message board. More specifically, the invention is directed to an illuminated message board that may include a base unit, which may engage a wall outlet, and a writing board that may be removably positioned on and illuminated by the base unit.

### BACKGROUND OF THE INVENTION

Message boards have a variety of constructions and designs. For example, the handheld “schoolhouse-style” slate chalkboard or a more modem messaging apparatus such as POST-IT® notes or similar single-sided adhesive pads can be used to write a message thereon and be left for another to read. However, such types of message boards or message pads become less reliable as night falls since the surrounding darkness may prevent the intended recipient from seeing and/or reading the message. Therefore, it would be advantageous to have a simple and portable message apparatus that is illuminated so that a particular message can be viewed regardless of the time of day or lighting conditions.

### SUMMARY OF THE INVENTION

The message board of the present invention includes a base unit and a writing board that can fit within a channel of the base unit and be removed therefrom. The base unit can include a light and may be operable to be plugged directly into a wall outlet. A switch can also be included on the base unit to activate and deactivate the light.

The base has a front surface with an arm extending outwardly therefrom and the arm having a flange spaced apart from and extending generally parallel to the front surface. The front surface, the arm and the flange define a channel, the channel having a dimension such that the writing board can fit and rest therein. The channel also has a floor region which allows light to shine therethrough. The writing board can have a written message thereon and is operable to allow light to illuminate the written message when placed within the channel of the base and light shines through the floor region of the channel. Using, for example, a wet erase fluorescent marker, a user may write a message on the writing board and then place the writing board back into the base unit so that the message may be illuminated by light shining through the floor region of the channel.

### BRIEF DESCRIPTION OF THE DRAWINGS

Reference will now be had to the attached drawings wherein like reference numerals refer to like parts throughout and wherein:

FIG. 1 is a front perspective view of an illuminated message board constructed in accordance with an embodiment of the present invention;

FIG. 2 is a rear perspective view of the illuminated message board of FIG. 1;

FIG. 3 is a side view of the illuminated message board of FIG. 1; and

FIG. 4 is a front view of the illuminated message board of FIG. 1.

### DETAILED DESCRIPTION OF THE INVENTION

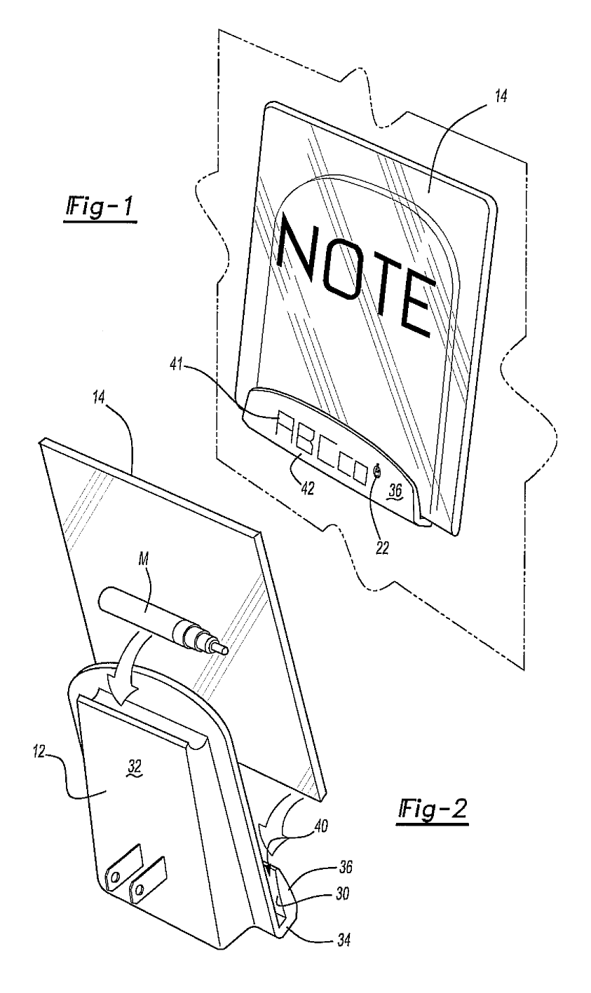

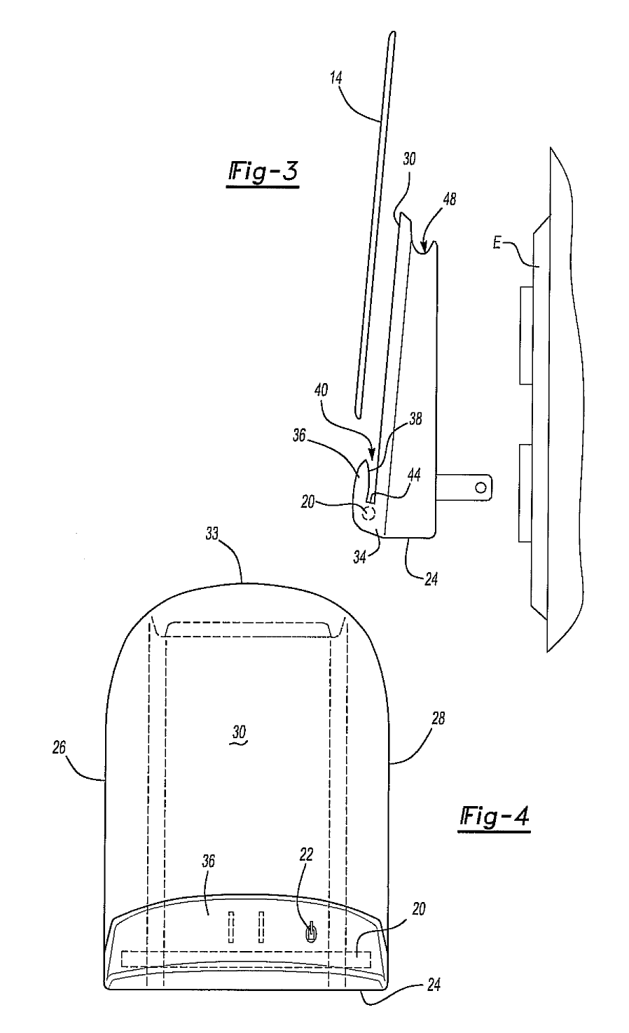

Referring now to FIGS. 1-4, an illuminated message board 10 may include a base 12 and a writing board 14 that may be removably positioned on the base 12. The base 12 may include an electrical connector 16 such that the base 12 may engage an electrical wall outlet E as shown in FIG. 3. Optionally, the base 12 may include an electrical connector that is operable to connect to a battery (not shown). The connector 16 may be in electrical communication with a light bulb assembly 20 that can be positioned in the base 12 and a switch 22 that can operate to selectively energize a light bulb within the light bulb assembly 20 and thereby illuminate the writing board.

Still referring to FIGS. 1-4, the base 12 can include a bottom surface 24, first and second side surfaces 26, 28, a front surface 30, a rear surface 32 and a top surface 33. The front surface 30 can include an arm 34 or extension portion proximate the bottom surface 24. In the alternative, the arm 34 is proximate the top surface 33 or one of the side surfaces 26, 28, A flange 36 can be positioned on the arm 34, the flange 36 being spaced apart from and extending generally parallel to the front surface 30. In this regard, the front surface 30, a rear face 38 of the flange 36, and the arm 34 can define a channel 40 that extends the length of the front surface 30 and is operable to removably retain the writing board 14. As shown in FIG. 1, advertising indicia 41, logos or the like may be positioned on a front face 42 of the flange 36.

The electrical connector 16 can extend from the rear surface 32 of the base 12. In addition, the channel 40 can include a floor region 44 with a window (not shown) that permits light from the light bulb assembly 20 to be transmitted through the channel 40 and across the front face 30 of the base 12. It is appreciated that the floor 44 of the channel 40 is illustrated as the most inward portion of the channel 40 whether the channel 40 is located proximate the bottom surface 24, the top surface 33 or one of the side surfaces 26, 28. The light bulb of the light bulb assembly 20 may be a fluorescent light bulb, an incandescent light, a light emitting diode (LED) or any other low heat light source. The switch 22 can be provided and located anywhere on the base 12 and selectively activates the light bulb assembly 20. In addition, more than one type of light bulb can be included within the light bulb assembly and the switch 22 can be operable to selectively activate each type of light bulb.

The top surface 33 of the base 12 can include a recess 48 that is dimensioned such that a writing instrument may be placed at least partially therein. For example, the recess 48 may be used to removably mount a wet erase fluorescent marker M or a similar type of writing instrument. As such, a user of the illuminated message board 10 can store a writing instrument using the recess 48 until its use is desired.

The writing board 14 can be a rectangular acrylic writing board that is dimensioned to fit within the channel 40 of the base 12. However, it will be appreciated that other materials and/or shapes may be used for the writing surface. Further, the writing board 14 may be constructed as a clear or translucent board such that when the writing board 14 is positioned in the channel 40, light from the light bulb assembly 20 is transmitted through the board 14 to illuminate a message written on the board.

In the above described manner, a user can tale the illuminated message board 10 and using batteries and/or an electrical outlet provide an illuminated message that can be seen independent of the lighting conditions in a given environment and used to portray a message to another individual. As such, the present invention has utility as a message board.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

1. A message board comprising:
a base having a front surface, said front surface having an arm extending outwardly therefrom, said arm having a flange spaced apart from and extending generally parallel to said front surface;
said front face, said arm and said flange defining a channel, said channel having a floor region operable to allow light to shine therethrough;
a light bulb assembly having a light bulb and operable to shine light through said floor region of said channel when said light bulb is energized;
an electrical connector electrically connected to said light bulb assembly and operable to connect to an energy source; and
a removeable writing board dimensioned to fit within said channel and rest generally parallel to said front surface of said base, said writing board operable to write a message on, be placed within said channel and allow light to illuminate said written message on said writing board.

2. The message board of claim 1, wherein the written message on said writing board is illuminated when said board is placed within said channel of said base and said light shines through said floor region of said channel.

3. The message board of claim 1, wherein said base has a recess operable to allow a writing instrument to be placed at least partially therein.

4. The message board of claim 3, wherein said recess is a generally horizontal recess.

5. The message board of claim 4, wherein said recess is proximate a top surface of said base.

6. The message board of claim 1, wherein said arm is proximate a bottom surface of said base.

7. The message board of claim 1, wherein said writing board is operable to allow fluorescent light to illuminate the written message on said writing board.

8. The message board of claim 7, wherein said light bulb assembly has a fluorescent light bulb.

9. The message board of claim 8, wherein the written message on said writing board is illuminated when said board is placed within said channel of said base and fluorescent light shines through said floor region of said channel.

10. The message board of claim 1, further comprising a switch electrically connected to said light bulb assembly and said electrical connector, said switch operable to energize and de-energize said light bulb.

11. The message board of claim 1, wherein said electrical connector extends outwardly from a back surface of said base.

12. The message board of claim 11, wherein said energy source is mains power.

13. The message board of claim 1, wherein said energy source is battery power.

14. A message board comprising:
a base having a front surface, said front surface having an arm extending outwardly therefrom, said arm having a flange spaced apart from and extending generally parallel to said front surface;
said front face, said arm and said flange defining a channel, said channel having a floor region operable to allow light to shine therethrough;
a light bulb assembly having a fluorescent light bulb and operable to shine fluorescent light through said floor region of said channel when said fluorescent light bulb is energized;
an electrical connector electrically connected to said light bulb assembly and operable to connect to an energy source; and
a removeable writing board dimensioned to fit within said channel and rest generally parallel to said front surface of said base, said writing board operable to write a message upon, be placed within said channel and allow fluorescent light to illuminate said written message on said writing board.

15. The message board of claim 14, wherein said base has a recess operable to allow a writing instrument to be placed at least partially therein.

16. The message board of claim 15, wherein said recess is a generally horizontal recess.

17. The message board of claim 16, wherein said recess is proximate a top surface of said base.

18. The message board of claim 14, wherein said arm is proximate a bottom surface of said base.

19. A message board comprising:
a base having a front surface, said front surface having an arm extending outwardly therefrom, said arm proximate a bottom surface of said base and having a flange spaced apart from and extending generally parallel to said front surface;
said front face, said arm and said flange defining a channel, said channel having a floor region operable to allow light to shine therethrough;
a light bulb assembly having a fluorescent light bulb and operable to shine fluorescent light through said floor region of said channel when said fluorescent tight bulb is energized;
an electrical connector electrically connected to said light bulb assembly and operable to connect to an energy source; and
a removeable writing board dimensioned to fit within said channel and rest generally parallel to said front surface of said base, said writing board operable to write a message upon, be placed within said channel and allow fluorescent light to illuminate said written message on said writing board.
